(19) United States
(12) Patent Application Publication
(10) Pub. No.: US 2023/0271657 A1
(43) Pub. Date: Aug. 31, 2023

(54) An Autonomous Mobile System, For Use In An Industrial Plant As A Reconfigurable Operating System

(71) Applicant: Comau S.p.A., Grugliasco (torino) (IT)

(72) Inventors: Enrico Mauletti, Grugliasco (Torino) (IT); Ivan Lazzero, Grugliasco (Torino) (IT); Enrico Rui, Grugliasco (Torino) (IT); Matteo Zarro, Grugliasco (Torino) (IT); Mauro Berzano, Grugliasco (Torino) (IT)

(73) Assignee: Comau S.p.A., Grugliasco (torino) (IT)

(21) Appl. No.: 17/769,064

(22) PCT Filed: Oct. 19, 2020
(86) PCT No.: PCT/IB2020/059802

§ 371 Date: Apr. 14, 2022

(30) Foreign Application Priority Data
Oct. 21, 2019 (IT) 102019000019442

(51) Int. Cl. B62D 63/04; G05D 1/02

(52) U.S. Cl. CPC B62D 63/04; G05D 1/0297

(57) ABSTRACT

An autonomous mobile system (100) used in an industrial plant as a mobile operator system, suitable to be easily reconfigured according to the needs of each specific application. The system (100) includes an autonomous vehicle (1), in the form of an autonomous mobile robot, and a transport carriage (10) including one or more operating units (12) configured to receive a load thereon to be transported. The autonomous vehicle (1) includes a coupling device (5) to couple the autonomous vehicle to the carriage (10) to move the carriage (10) along a path, while the weight of the load carried on the carriage (10) rests solely on the carriage (10). The autonomous vehicle (1) is configured to control the devices onboard the carriage (10).

### CROSS-REFERENCE TO RELATED APPLICATIONS

This application is filed pursuant to 35 USC 371 claiming priority benefit to PCT/IB2020/059802 filed Oct. 19, 2020, which claims priority benefit to Italian Patent Application No. 102019000019442 filed Oct. 21, 2019, the contents of both applications incorporated herein by reference in their entirety.

### TECHNICAL FIELD

The present invention relates to an autonomous mobile system, for use in an industrial plant as a reconfigurable operating system.

### BACKGROUND

In recent years, the use of autonomous vehicles for transporting items, components or groups between stations of a production plant has become increasingly widespread in industrial plants. According to the terminology currently in use, a first type of autonomous vehicle consists of the so-called AGVs (“Automated Guided Vehicles”), which require the provision of an infrastructure, for example, in the form of magnetic strips on the floor, or navigation beacons to guide the vehicle along a predetermined path. A second type of autonomous vehicle is the so-called “AMRs” (“Autonomous Mobile Robots”), which instead move using a navigation system and a processor that are on board the robot. AMRs are able to perceive the environment in which they move and make decisions based on what they perceive and how they have been programmed, for example, stopping, departing again, and maneuvering around obstacles that they encounter along their path. The invention is conceived with particular reference to the use of an autonomous vehicle of the AMR type and starts from the need to identify new uses of vehicles of this type that allow improvement in flexibility and efficiency of production plants and also reduction in the costs necessary to adapt the plants to production needs in continuous and rapid evolution.

An autonomous mobile system according to the preamble of claim 1 is known from WO 2015/059560 A1.

### SUMMARY

Therefore, an object of the present invention is to produce an autonomous mobile system for use in an industrial plant that can be advantageously used as a transport system and/or as an operator system in order to create highly flexible and efficient production systems, which involve relatively low investment costs and are easily reconfigurable.

Another object of the invention is to produce an autonomous mobile system that has a standardized base part, which remains unaltered whatever the industrial environment and the specific application it is intended for, and which can then be implemented with an application part that can be configured in function of the specific intention, with physical and logical interfaces between the standard base part and the specific application part that are defined a priori.

In order to achieve this aim, the invention relates to a reconfigurable autonomous mobile system, for use in an industrial plant as a transport system and/or operating system, said autonomous mobile system comprising an autonomous vehicle including a main body, mounted on one or more motorized wheels and on one or more steering wheels, wherein said main body carries at least one first electric motor for transmitting power to said motorized wheels, and at least one second electric motor to control the steering of said steering wheels, and wherein the main body of the autonomous vehicle also carries a detection system to detect the environment surrounding the autonomous vehicle, and one or more electronic controllers configured to receive data detected by said detection system and to control said at least one first electric motor and said at least one second electric motor,

wherein said system also includes a transport carriage having a structure configured to receive a load thereon to be transported, and one or more operating units,

wherein the autonomous vehicle is provided with at least one coupling device for coupling with said carriage and is configured to be arranged adjacent to said carriage, in a position wherein said coupling device can be brought from a rest position to an operative position for coupling with the carriage, so that said vehicle is able to move said carriage along a path, while the weight of the load carried on the carriage rests solely on the carriage,

wherein said carriage is configured to carry one or more of said operating units by means of respective adapter elements, which enable the carriage to be adapted to one or more units to be transported thereon,

wherein said operating units carried on the carriage are controlled by one or more electronic controllers, and

wherein one or more of said electronic controllers controlling the operating units carried on the carriage are arranged on said autonomous vehicle, said coupling device also comprising an electrical connector device for connection between said one or more operating units carried by the carriage, and one or more electronic controllers carried by the autonomous vehicle,

said autonomous vehicle being an autonomous mobile robot.

Thanks to the aforesaid characteristics, the autonomous mobile system according to the invention can be used in an industrial plant not only for the transport of loads, but also to constitute itself, together with the operating units that can be associated therewith, a mobile operator system intended to complete a series of operations in the production cycle implemented in the industrial plant. The system according to the invention, thanks to the provision of the aforesaid adapter elements, can be easily reconfigured by equipping it with one or more operating units, which can also be constituted by standardized devices, but which thus allow a rapid reconfiguration of the system each time, based on specific application needs. A key characteristic of the invention is that the autonomous vehicle forming part of the autonomous mobile system of the invention has an intelligence that is used not only to control the operation of the autonomous vehicle, but also to control one or more operating units that are carried by the carriage that is coupled to the autonomous vehicle.

At the same time, by arranging the loads to be transported, as well as one or more operating units, on a carriage which is independent with respect to the autonomous vehicle, different functions can be assigned to different components. The carriage is assigned the function of supporting the weight of the transported load and the operating units, while the autonomous vehicle coupled to the carriage is assigned the function of guiding the movement of the carriage and of carrying programmed electronic hardware to control the operation of the units carried by the carriage.

In the preferred embodiment in which the autonomous vehicle is an AMR vehicle, said vehicle carries a plurality of sensor devices for detecting the environment surrounding the autonomous vehicle and/or for detecting the absolute position of the autonomous vehicle, and a wireless communication system with a control center.

In the preferred example, the aforesaid carriage comprises a structure mounted on pivoting wheels and is configured to receive the aforesaid adapter elements for mounting one or more operating units.

In an exemplary embodiment, the transport carriage has a structure spaced apart from the ground by a height greater than the maximum vertical bulk of said autonomous vehicle, and the autonomous vehicle is configured to be positioned below said structure of the carriage in a position in which said coupling device can be carried from a lowered rest position to a raised coupling position. In the case of this embodiment, the carriage has an upper structure from which two side structures protrude downwards, defining a tunnel-like passage within which the upper part of the autonomous vehicle is received. Preferably, the aforesaid tunnel-like passage is equipped with guide systems, for example consisting of freely rotatable wheels, to guide the insertion of the autonomous vehicle into the tunnel-like passage of the carriage.

Furthermore, again preferably, the autonomous vehicle and the carriage may be equipped with electronic detection and guide systems of any known type, communicating with each other, which allow the “docking” maneuver to be carried out between the carriage and the autonomous vehicle in a completely automatic way.

When the autonomous vehicle is inserted below the carriage, within the aforesaid tunnel-like passage, an electric drive motor arranged on the autonomous vehicle controls the lifting of the device for coupling between the autonomous vehicle and the carriage. This device also includes one or more electrical connectors configured to cooperate with one or more electrical connectors carried by the carriage to create electrical communication between the operating units carried on the carriage and the electronic controllers mounted on board the autonomous vehicle, below the carriage.

In a variant, the autonomous vehicle is configured to couple with the carriage by arranging itself adjacent to one side of the carriage structure.

Thanks to all the characteristics indicated above, the mobile system according to the invention is able to optimally satisfy the reconfiguration needs of the operating systems in an industrial plant, being totally open to any type of implementation by adding components or operating units, according to the specific application needs.

The system according to the invention allows greater flexibility and simplification also in terms of software control, since at least part of the electronic control of the operating units, which are arranged above the carriage, is assigned to electronic circuits carried by the autonomous vehicle, which can be programmed each time according to specific application needs.

### BRIEF DESCRIPTION OF THE DRAWINGS

Further characteristics and advantages of the invention will become apparent from the description that follows with reference to the attached drawings, provided purely by way of non-limiting example, wherein:

FIG. 1 is a perspective view of an autonomous vehicle forming part of an autonomous mobile system according to the invention;

FIG. 2 is a perspective view showing the autonomous vehicle of FIG. 1 in a coupled condition below a carriage carrying an operating unit, specifically a manipulator robot;

FIG. 3 shows another application example of the invention, wherein two autonomous vehicles of the type illustrated in FIG. 1 are used to move a single carriage intended to carry a motor-vehicle body in an industrial plant; and

FIG. 4 is a schematic side cross-sectional view of an autonomous mobile system according to the invention.

### DETAILED DESCRIPTION

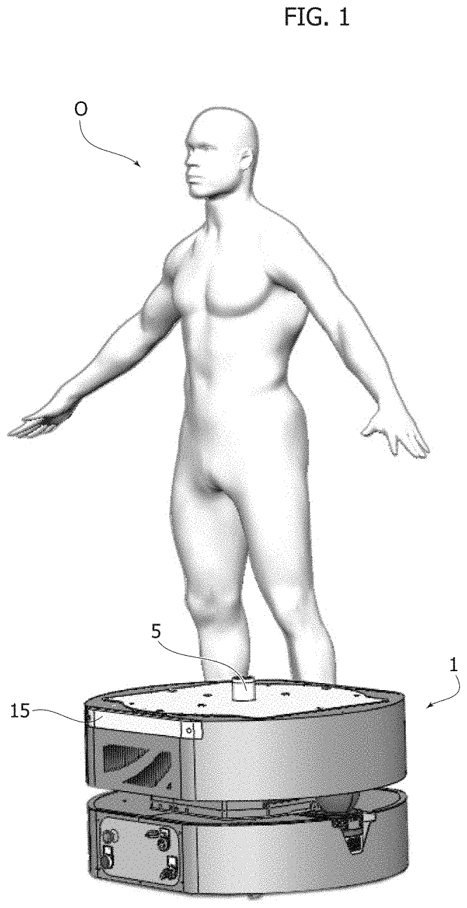

In FIG. 1, the reference number 1 indicates—in its entirety—an autonomous vehicle, specifically an autonomous mobile robot (AMR) used in the system according to the invention.

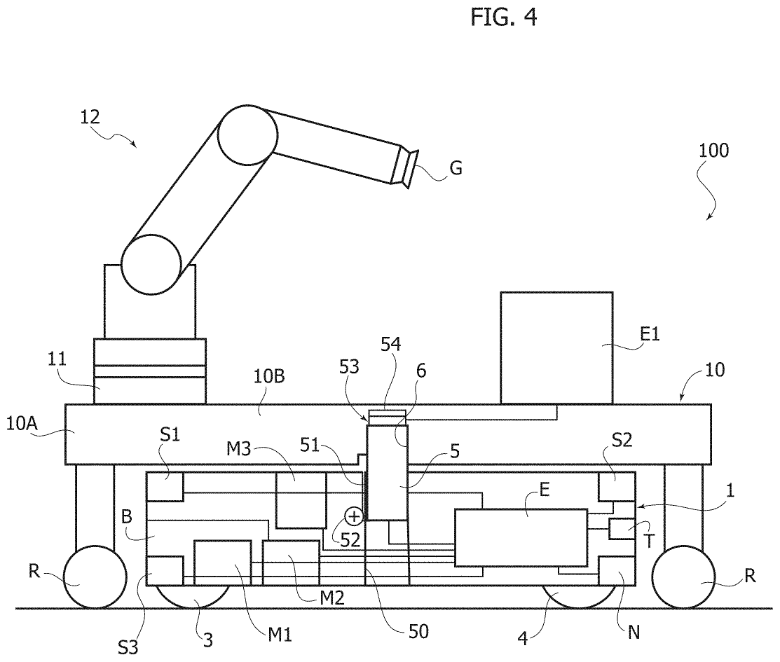

The construction details relative to the structure and configuration of the AMR 1, as well as the various devices that are carried thereby, are not described or illustrated herein, since they can be made in any known way. Elimination of these details from the drawings also renders the drawings simpler and easier to understand. The general configuration of the AMR 1 is described below with reference to FIG. 4, which shows a simplified diagram of this vehicle.

With reference to FIG. 4, the AMR 1 has a structure of any known type, mounted on wheels 3, 4. Three, four or more wheels may be provided, according to what is generally known in the art of autonomous mobile robots. At least some of the wheels 3, 4 are drive wheels driven by an electric motor M1 placed on board the AMR. At least some of the wheels 3, 4 are also steering wheels, the steering of which is controlled by at least one additional electric motor M2 also located on board the AMR 1. According to the conventional art, the electric motors M1, M2 located on board the AMR 1 are controlled by one or more electronic controllers located on board the AMR 1, schematically represented in FIG. 4 by block E. According to a first prior art, the steering wheels of the vehicle 1 may only be able to steer within a maximum predetermined angle, or, according to an alternative technique, also known per se, they can be pivoting wheels, capable of steering by 360°, controlled by a respective electric motor.

Also on board the AMR 1 there is an energy storage system (B), for example a pack of rechargeable batteries B, for the power supply of the electrical devices located on board the AMR 1. Furthermore, according to techniques known per se, the AMR 1 is equipped with a module T of any known type for wireless communication with a control unit located in the industrial plant wherein the system according to the invention is intended to be used. The transmission module T is connected to the electronic controller E. This electronic controller E is also connected to a plurality of sensors S1, S2, S3 (three shown) of any known type, configured for detecting the environment surrounding the autonomous vehicle and transmitting the data collected by the electronic controller E. For this purpose, various technologies can be used. A first type of sensor is constituted by the so-called “lidar” sensors, which use a laser technology to measure the distance from an object. Lidar sensors perceive the environment surrounding the vehicle in three dimensions. They ensure the detection of obstacles and allow calculation of the vehicle position thanks to a 2D or 3D mapping. It is also possible to use video cameras to analyze the surroundings of the vehicle. The video cameras can be used in association with electronic controllers programmed with algorithms capable of categorizing obstacles. In addition, the AMR 1 may also be equipped with a device N for satellite navigation, which allows detection of the absolute position of the vehicle with an accuracy close to one centimeter.

In accordance with further known technologies, it is also possible to use radar devices, to determine the position and speed of surrounding objects and for long-distance viewing. The AMR may also be equipped with an odometer, to estimate and confirm the position and speed of the vehicle, as well as inertial measurement devices, to detect vehicle accelerations and rotations in order to confirm vehicle position information and improve accuracy.

With reference again to FIG. 4, the system according to the invention, generally designated by reference numeral 100, makes use of the AMR 1 described above in combination with a carriage generally designated by 10. The carriage 10 has a structure 10A of any known type, mounted on wheels R. In the preferred embodiment illustrated herein, the wheels R of the carriage 10 are all non-motorized pivoting wheels.

As illustrated schematically in FIG. 4, in the case of the example described herein, the AMR 1 is intended to be coupled with the carriage 10 by placing itself therebelow. However, it is possible to envisage that the autonomous vehicle is configured to couple with the carriage by arranging itself adjacent—to one side of the carriage structure.

In the example illustrated, the structure 10A is supported on the wheels R so as to have an upper part 10B raised above the ground, by a distance greater than the maximum height of the AMR 1. Thanks to this characteristic, and thanks to the fact that between the wheels R—on the two sides of the carriage 10—a space remains free in the transversal direction of the carriage, which is greater than the maximum transverse dimension of the AMR 1, the AMR 1 is free to arrange itself below the upper part 10B of the carriage structure. In the aforesaid condition, the AMR 1 is able to be coupled to the carriage 10 by means of a coupling device 5.

In FIG. 4, by way of example, the coupling device 5 is illustrated in the form of an element movable in the vertical direction, slidably mounted within a guide 50 formed in the structure of the AMR 1. Again in the case of the illustrated example, the coupling device 5 carries a rack 51 meshing with a pinion 52, controlled by an electric motor M3. In this case as well, the construction details of these components and their connections are not illustrated, since they can be made in any known way.

Thanks to the arrangement described above, the coupling device 5 can be moved between a lowered position (or rest position), all contained within the AMR 1, and a raised position (or operative position), illustrated in FIG. 4, wherein the upper part of the device 5 is received in a cooperating cavity 6 formed in the lower surface of the upper part 10B of the carriage 10. The arrangement is such that, in this coupling condition, the carriage 10 is completely associated in its movements with the movements of the AMR 1.

According to an additional characteristic of the invention, the coupling device 5 also comprises an electrical connector device 53 carried by the device 5, which cooperates with a corresponding electrical connector 54 carried by the carriage 10, to create an electrical connection between the electrical devices carried by the carriage 10 and the electronic controller E located on board the AMR 1, and also possibly with the battery pack B of the AMR 1.

The system 100 as described above is, therefore, able to perform different functions with different components. The autonomous vehicle constituted by the AMR 1 is assigned the function of guiding the movement of the carriage 10, while the carriage 10 is assigned the function of supporting the weight of the loads transported thereon.

According to the invention, the carriage 10 is arranged with one or more adapter devices 11, which allow one or more operating units 12 to be secured above it, intended to perform operations in a cycle of operations envisaged in the industrial plant in which the mobile system 100 is used. In the example illustrated in FIG. 4, the operating unit 12 is a multi-axis manipulator robot of any known type, provided with an end-effector in the form, for example, of a gripper equipped with vacuum-activated suction cups, which is schematically illustrated in the drawing and indicated with the reference G (of course, this example is not limiting).

The operating units 12 arranged on the carriage 10 can be more than one and of different types. For example, an operating unit in the form of a lifting device able to move a structure carried on the mobile system 100 between a lowered position and a raised position can be arranged on the carriage 10. An operating unit of this type can be used by the mobile system 100, for example, to transport a motor-vehicle body intended to be subjected to a series of welding operations in a welding station. The lifting device, once the mobile system 100 has entered the welding station, can be lowered to release the body carried thereby onto locking systems provided in the welding station. Once the cycle of welding operations has been completed, the lifting device is raised again to take the load of the welded body again, and to transport it to the subsequent stations of the production plant.

The case is also not excluded in which an item or component carried on the carriage 10 is subjected to a series of assembly operations by one or more operating units carried on the carriage 10, during the movement of the autonomous mobile system 100 from one station to another in the production plant, in order to reduce production time.

In the case of the example illustrated in FIG. 4, an electronic controller E1 can also be transported on the carriage 10, for controlling the manipulator robot 12. However, according to the invention, at least part of the intelligence that controls one or more operating units arranged on the carriage 10 is located inside the autonomous vehicle 1 in one or more electronic units schematized in FIG. 4 by block E. This characteristic allows further simplification and standardization of the system according to the invention by making it easier to reconfigure the system, also in terms of software programming.

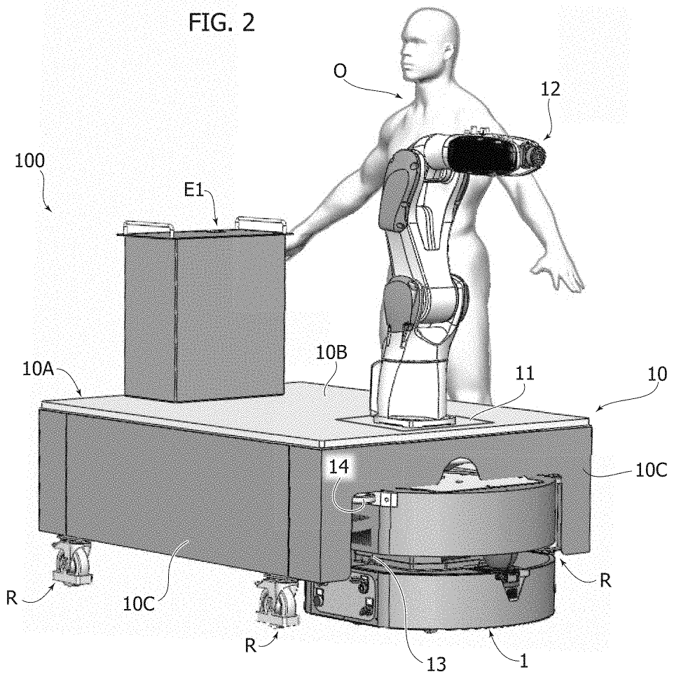

FIG. 2 shows an actual exemplary embodiment of the solution schematically illustrated in FIG. 4. In the case of this embodiment example, the structure 10A of the carriage 10 comprises an upper portion 10B defining a flat surface above which the adapter element 11—serving for mounting the manipulator robot—12 is arranged. The electronic controller E1 of the robot is also arranged on the upper surface of the carriage 10.

The structure 10A of the carriage 10 also has two side portions 10c extending downwards from the upper portion 10b, at its two sides, and carrying the pivoting wheels R. As can be seen in FIG. 2, the conformation of the structure 10A of the carriage 10 is such that the carriage defines a tunnel-like passage 13 on its lower side, within which the autonomous vehicle 1 is received.

Again in the case of the illustrated example, on the wall of the tunnel-like passage 13, guide systems of any type are provided to guide an insertion movement of the AMR 1 into the tunnel-like passage 13, below the carriage 10. In the specific case illustrated, in particular, the lower surface of the upper part 10B of the carriage carries a plurality of freely rotating wheels 14 (or guide members), with vertical axis, arranged to be engaged by rolling over side guide tracks 15 (one of which is visible in FIG. 1) arranged on the two opposite sides of the body of the AMR 1.

According to another preferred characteristic, the carriage 10 and the AMR 1 are arranged with sensor devices and communication devices to assist in the docking operation between the AMR 1 and the carriage 10, configured to allow this docking operation to be carried out automatically.

Naturally, according to the invention, a plurality of carriages 10 of various types can be arranged in the industrial plant, as well as a plurality of AMRs 1, capable of being flexibly coupled to the aforesaid carriages 10 to create a variety of different production cycles. Position indicator devices or signaling systems may be provided on the carriages 10 in communication with a control unit set up in the industrial plant, which is thus able to detect the position of the carriages 10, as well as communicate with the AMRs 1 to control docking operations between certain AMRs and certain carriages, according to production needs, and taking into account any failures and need for replacement.

It is also possible to provide a pulling device on the AMR 1, which can be connected to a hook of the carriage 10, to allow the AMR 1 to pull the carriage 10. It is also possible to envisage that the same carriage is coupled with more than one AMR 1.

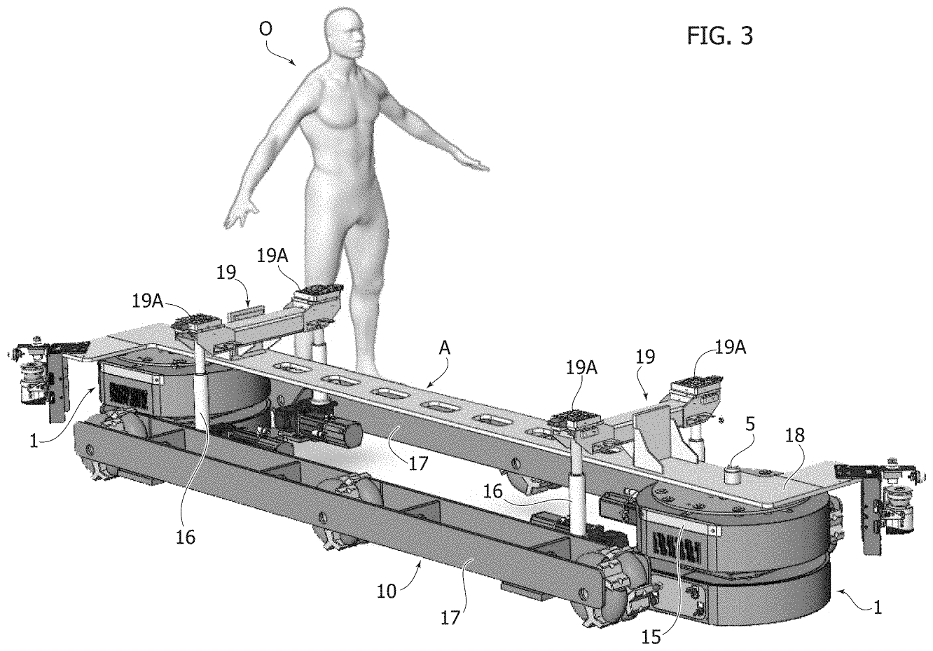

By way of example, FIG. 3 shows the case wherein a carriage 10 intended to support a motor-vehicle body, or a body subassembly or any other component, and to transport it through the different stations of the production plant, said carriage 10 being carried by a pair of AMRs 1 longitudinally spaced apart.

More generally, a “swarm” of vehicles can be envisaged, which collaborate with each other for transporting loads greater than those allowed by a single vehicle. In this case, it can be envisaged that in the swarm of vehicles there is a “master” vehicle and a series of “slave” vehicles.

Again in the case of the example illustrated in FIG. 3, the structure of the carriage 10 comprises two longitudinal beams 17, which are parallel and spaced apart, joined at their ends by cross-member structures 19. In this case, the frame including the two longitudinal beams 17 includes cylinder lifting devices 16, which allow the structure intended to receive the load to be transported, to be moved vertically. More specifically, this structure includes an elongated longitudinal plate 18, arranged horizontally, the ends of which have cavities intended to be engaged, respectively, by coupling devices 5 with which the AMRs 1 are equipped. The plate 18—in turn—is connected rigidly to structures 19, which are provided with supporting elements 19A for locating and supporting a structure to be transported.

FIGS. 1-3 illustrate an operator O located adjacent to the mobile system 100 (only the autonomous vehicle 1 shown in FIG. 1) according to the invention. Preferably, the system 100 according to the invention is designed according to “collaborative” criteria, i.e. to be able to operate in an open unprotected environment, adjacent to the operators, safeguarding, in any case, the total safety of the operators themselves. To this end, each AMR 1 is preferably programmed to detect an operator O in its vicinity, by means of sensor devices with which it is equipped, and to slow down its speed or stop completely in order to avoid a collision. For the same reason, if a manipulator robot 12 is arranged on the carriage 10, the robot can be a collaborative robot, that is, configured and/or programmed to be able to operate in an open environment ensuring the safety of the operators. Various types of collaborative robots are known in the art, which use different types of technologies in order to achieve the above indicated object. For example, collaborative robots of a type developed by the same Applicant can be used, equipped with a sensorized skin that is able to predict or detect contact with a foreign body in order to avoid any dangerous condition for the operators.

Naturally, without prejudice to the principle of the invention, the details of construction and the embodiments may vary widely with respect to those described and illustrated purely by way of example, without departing from the scope of the present invention.

1. A reconfigurable autonomous mobile system (100), for use in an industrial plant as a transport system or operating system, said autonomous mobile system comprising an autonomous vehicle (1) including a main body, mounted on one or more motorized wheels (3, 4) and on one or more steering wheels (3, 4), wherein said main body carries at least one first electric motor (M1) for transmitting power to said motorized wheels (3, 4), and at least one second electric motor (M2) for controlling the steering of said steering wheels (3, 4), and wherein the main body of the autonomous vehicle (1) also carries a detection system (S1, S2, S3) to detect an environment surrounding the autonomous vehicle (1), and one or more electronic controllers (E) configured to receive data detected by said detection system (S1, S2, S3) and to control said at least one first electric motor (M1) and said at least one second electric motor (M2),
wherein said system (100) also includes a transport carriage (10) having a structure (10A) configured to receive a load thereon to be transported, and one or more operating units (12),
wherein the autonomous vehicle (1) is provided with at least one coupling device (5) for coupling with said carriage (10) and is configured to be arranged adjacent to said structure (10A) of the carriage (10) in a position in which said coupling device (5) can be moved from a rest position to an operative position for coupling with the carriage (10), so that said autonomous vehicle (1) is able to move said carriage (10) along a path, while a weight of the load carried on the carriage (10) rests solely on the carriage (10),
wherein said carriage (10) is configured to carry one or more of said operating units (12) by means of respective adapter elements (11), which enable the carriage (10) to be adapted to one or more operating units (12) to be transported thereon,
wherein said operating units (12) carried on the carriage (10) are controlled by one or more electronic controllers, and
wherein one or more of said electronic controllers controlling the operating units (12) carried on the carriage (10) are arranged on said autonomous vehicle (1), said coupling device (5) also comprising an electrical connector device (53, 54) between said one or more operating units (12) carried by the carriage (10), and one or more electronic controllers (E) carried by the autonomous vehicle (1);
said system (100) being characterized in that said autonomous vehicle (1) is an autonomous mobile robot.

2. The autonomous mobile system according to claim 1, characterized in that said autonomous mobile robot (1) detection system (S1, S2, S3) further comprises at least one of a lidar device, a video camera, a radar device or a satellite-based device for position detection.

3. The autonomous mobile system according to claim 1, characterized in that the autonomous vehicle (1) carries an energy storage system (B) configured to supply power to electric devices on board the autonomous vehicle (1); and a transmission module (T) for wireless communication (T), configured to communicate with a central control system in the industrial plant.

4. The autonomous mobile system according to claim 1, characterized in that said carriage (10) structure (10A) is spaced apart from a ground by a height greater than a maximum vertical bulk of said autonomous vehicle (1), and that the autonomous vehicle (1) is configured to be positioned below said structure (10A) of the carriage (10) in a position wherein said coupling device (5) can be moved from the rest position to the operative position to couple the autonomous vehicle (1) to the carriage (10).

5. The autonomous mobile system according to claim 4, characterized in that the carriage (10) structure (10A) further comprises an upper portion (10B) from which two side portions (10C) protrude downwards, so as to define a tunnel-like passage (13) below the carriage (10) configured to receive said autonomous vehicle (1) therewithin.

6. The autonomous mobile system according to claim 5, characterized in that said tunnel-like passage (13) has walls on which guide members (14) are arranged, said guide members cooperating with two opposite side walls of the main body of the autonomous vehicle (1) to guide the insertion of the autonomous vehicle within said tunnel-like passage (13).

7. The autonomous mobile system according to claim 6, characterized in that said guide members are in the form of freely rotatable wheels (14) having vertical axes and configured to engage guide tracks (15) carried by the two opposite side walls of the main body of the autonomous vehicle (1).

8. The autonomous mobile system according to claim 1, characterized in that said autonomous vehicle (1) and said carriage (10) are provided with detection and communication devices cooperating with each other configured to assist an automatic docking operation between the autonomous vehicle (1) and the carriage (10), by which the autonomous vehicle (1) is automatically guided within a tunnel-like passage (13) defined by the carriage (10).

9. The autonomous mobile system according to claim 1, characterized in that the autonomous vehicle (1) is configured to be coupled with the carriage by being arranged adjacent to one side of said carriage structure (10A).

10. An industrial production plant using a plurality of autonomous mobile systems (100) according to claim 1, said plant comprising a plurality of autonomous vehicles (1); a plurality of carriages (10); and a control unit, which is able to cooperate with position indicator devices arranged on the carriages (10), and with transmission modules (T) arranged on the autonomous vehicles (1) to detect the position of the carriages (10) and the position of the autonomous vehicles (1), and to command a docking maneuver of one or more autonomous vehicles (1) with respective carriages (10) in order to couple said autonomous vehicles (1) with said carriages forming respective autonomous mobile systems (100), said control unit being configured to control the autonomous mobile systems (100) thus formed in order to perform predetermined operating cycles.

11. The autonomous mobile system of claim of claim 4, wherein the coupling device (5) rest position is a lowered position and the operative position is a raised position.
